(19) United States
(12) Patent Application Publication
(10) Pub. No.: US 2011/0060077 A1
(43) Pub. Date: Mar. 10, 2011

(54) Process for Manufacturing High-Performance Natural Fiber Reinforced Composites

(76) Inventors: Yeng-Fong Shih, Wufong Township (TW); Chien-Chung Huang, Wufong Township (TW); Po-Wei Chen, Wufong Township (TW)

(21) Appl. No.: 12/556,743

(22) Filed: Sep. 10, 2009

(51) Int. Cl. C08L 97/02; D01C 1/00; D21B 1/04; D21C 3/00

(52) U.S. Cl. 524/9; 162/1; 162/94; 162/99; 162/28; 162/72

(57) ABSTRACT

In this patent, fibers have been successfully extracted from various natural occurring materials using a series of chemical, biological and mechanical methods. Moreover, these fibers can be conjugated onto certain polymer chains via coupling agent and chemical modification. Consequently, the thermal stability and mechanical properties of the polymers can be dramatically elevated with the incorporation of these fibers. The intended polymers include conventional plastics (epoxy resins, polyesters and polyolefins etc.), rubbers (natural rubbers and thermoplastic rubbers etc.) and biodegradable polymers. Apart from the enhancement of mechanical properties and thermal stability, the incorporation of natural fibers can reduce the production cost of the materials and meet the demand of environmental protection.

### FIELD OF THE INVENTION

The present invention relates to a process for manufacturing high performance natural fiber reinforced composites, in particular to a process for manufacturing high performance natural fiber reinforced composites, using chemical, biological and mechanical treatments to successfully extract natural fibers from naturally occurring materials which can be applied to conventional plastics (for example epoxy resins, polyesters and polyolefins), rubbers (for example natural rubbers, thermoplastic rubbers, such as TPR) and biodegradable plastics.

### DESCRIPTION OF THE PRIOR ART

Crude oil price has successively soared in recent years, which was doubled from 2003 (USD 28.1) till 2006 (USD 61.24). In 2008, the price rise even exceeded USD 100. Accordingly, the cost of products out of crude oil, such as for example synthetic fibers, is increasingly being raised. Although crude oil price has dropped at the moment, we shall still confront the dilemma of gradual exhaustion and prices surge of crude oil due to its limited deposits. It was reported by Fashion Express that the main exhibition-attending chemical corporations in the European Exhibition on Yams and Fibers, Expofil, expressed that because synthetic fibers are mainly made out of crude oil products, the increase in crude oil price over the past time led to continuous price elevation of synthetic fibers and this caused a heavy cost pressure on the related companies. As a result, it is difficult for the manufacturers to endure the successive price increases.

Furthermore, Taiwan's agricultural skills have been well developed and hence there exist plentiful kinds of agricultural products. On the other hand, it is indicated by investigation that the total agricultural wastes generated each year in Taiwan amounts to approximately 23 million tons. In contrast, many countries in the world make every effort to develop natural fibers to replace synthetic fibers. In addition, there is also the fact that natural fibers are not only inexpensive, but do not also cause allergies in the human body. Moreover, they still have advantages of light weight and energy saving. Accordingly, they will be increasingly highly regarded in the future when crude oil may be inadequately supplied. But when both these agricultural products and wastes can be well utilized, they can not only elevate the level of domestic industry, but also promote the agricultural development. However, it is generally necessary to add more than 20% (weight %) of plant fibers to the plant fiber reinforced composites so that it can exhibit a remarkable reinforcing effect. If the addition reaches more than 40% (weight %), a serious phase separation occurs frequently and worsens the quality.

### SUMMARY OF THE INVENTION

Accordingly, the inventor of the present invention actively developed a process for manufacturing high performance natural fiber reinforced composites, wherein natural fibers were extracted from naturally occurring materials and the generated fibers could be applied respectively to conventional plastics, rubbers and biodegradable plastics in order to reinforce the mechanical strength of the materials, to raise the thermal stability, to lower the cost of the materials and to conform to the request of eco-friendly composites. After a number of experiments and modifications, the present invention is accomplished eventually.

It is the primary object of the present invention to develop a technique of extracting fibers from agricultural products, naturally occurring materials and agricultural wastes and to further provide the generated fibers for composite industry in order to promote domestic industrial and agricultural development and to reduce industrial dependence on synthetic fibers.

[symbol]

[symbol]

[symbol]

[symbol]

The secondary object of the present invention is to successfully extract natural fibers with excellent properties from agricultural products, naturally occurring materials and agricultural wastes and to add the generated fibers following surface modification to widely used rubbers and plastics and biodegradable plastics to produce composites. The mechanical property and thermal stability of the materials can be effectively elevated only by adding less than 10% (weight %) of natural fibers.

[symbol]

[symbol]

[symbol]

### BRIEF DESCRIPTION OF THE DRAWING

FIG. 1 is a flow chart of the manufacturing process of the preferable embodiment according to the invention.

### EMBODIMENT OF THE INVENTION

To achieve the aforementioned objects, the subject matter and features of the present invention will be further detailed in the following text in combination with the attached figure. We believe this enables the subject matter of the present invention and the exerted effects thereof to be further understood.

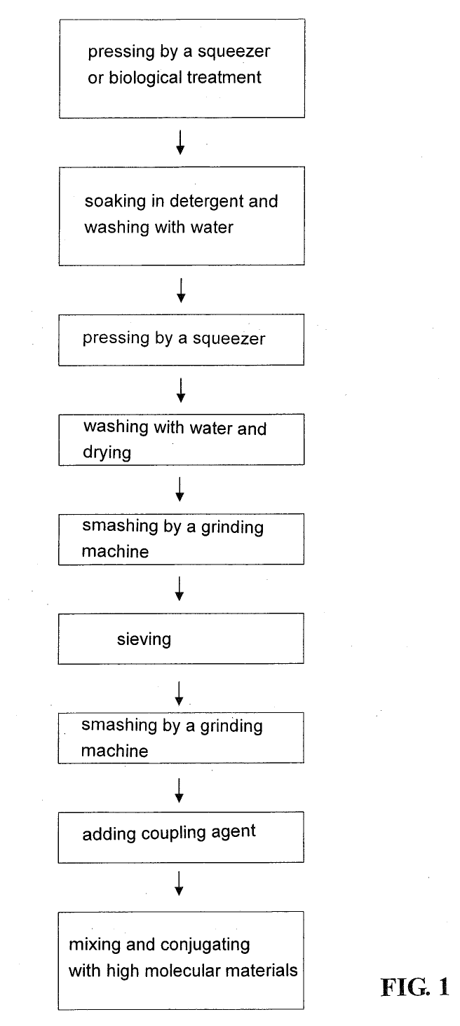

Reference is made to FIG. 1, wherein the procedure of manufacturing high performance natural fiber reinforced composites is shown as follows:
1. mechanical or biological treatment: first of all, the raw materials were pressed with a squeezer (0.5˜2 hP) or soaked in water in order that they were degraded biologically,
2. degreasing treatment: the fibers generated in the first step were soaked in 2˜5% detergent solution at 40˜80° C. for 1˜3 hr and then washed with water,
3. The fibers generated in the second step were pressed again by a squeezer (0.5˜2 hP),
4. The fibers generated in the third step were washed with water and dried at 80˜120° C. for 6˜24 hr,
5. The fibers generated in step 4 were smashed by a grinding machine (0.5˜2 hP, duration: 2˜10 sec),
6. The fibers generated in step 5 were sieved (20 mesh, 0.84 mm),
7. The fibers generated in step 6 were smashed once again by a grinding machine (0.5˜2 hP, duration: 2˜10 sec) until the desired length was reached; after grinding, fibers of diameter in the range of 0.003˜0.014 mm, length in the range of 0.2˜15 cm and aspect ratio >50 were generated,
8. treatment with coupling agent: the coupling agent can form physical bonding which serves to increase the compatibility between the fibers generated in step 7 and the plastics; the coupling agent was mixed with acetone in the ratio of 3:100 (V/V) and stirred at room temperature; the fibers were then weighed out and mixed with acetone in the proportion of 25:1000 (W/V); then the mixture was added to the coupling agent; 5 g of filling agent and 0.5 g of silane were added, whereby the filling agent used in the embodiment was fibers, which was stirred at room temperature for 30˜60 min and subsequently let stand for 10˜30 min until the fibers precipitated; after precipitation, the supernatant was decanted; the residue was sealed with Teflon foil and then let stand at room temperature for 12 hr; the residue was then washed with acetone to remove the remaining coupling agent from the residue in order to retain the modified fibers; the modified fibers were placed in an oven and dried at 80° C. until the weight did not change any more,
9. The modified fibers in step 8 were mixed with high molecular materials (biodegradable plastics or conventional high molecular materials) and diverse conjugation reactions were designed in accordance with the chemical structural features of the high molecular materials in order to conjugate the fibers to the side chains of the high molecular materials and thus form fiber reinforced plastics.

As a result, natural fibers with excellent properties can be produced using a series of chemical, biological and mechanical treatments, wherein the generated fibers can be conjugated to the main chain of the high molecular materials with the aid of coupling agent and by chemical treatment; the thermal stability and mechanical property of the high molecular materials can be effectively elevated by adding less than 10% (weight %) of the natural fibers; the fibers can be applied respectively to conventional plastics (for example epoxy resins, polyesters and polyolefins), rubbers (for example natural rubbers, thermoplastic rubbers, such as TPR) and biodegradable plastics in order to reinforce the mechanical strength of the materials and reduce the cost thereof (see the embodiment 1). When modified fibers are added to polypropylene, the heat deflection temperature (HDT) can increases from 80° C. to 140° C., whereby the increase rate is 75%, and the tensile strength increases from 31.5 MPa to 51.9 MPa, whereby the increase rate is 65%.

### Embodiment 1

| | | |
|---|---|---|
| coupling agent | plant fiber | modified plant fiber |
| maleic acid-modified PP | modified plant fiber | plant fiber |
| | | reinforced composite |

| | Temperature of thermal | Tensile strength |
|---|---|---|
| materials | deformation HDT (° C.) | (MPa) |
| PP | 80 | 31.5 ± 0.8 |
| PP/10 phr modified fiber | 117.2 | 35.3 ± 0.51 |
| PP/20 phr modified fiber | 122.2 | 39.7 ± 0.39 |
| PP/40 phr modified fiber | 138.5 | 51.9 ± 0.57 |
| PP/60 phr modified fiber | 144.8 | 49.0 ± 0.8 |

Reference is made to the embodiment 2. When modified fibers are added to polylactic acid, the heat deflection temperature (HDT) can increases from 62.6° C. to 139° C., whereby the increase rate is 100%, and the tensile strength increases from 39.3 MPa to 78.6 MPa, whereby the increase rate is 100%.

### Embodiment 2

| | | |
|---|---|---|
| plant fiber | coupling reagent | modified plant fiber |
| modified plant fiber | polylactic acid (PLA) | plant fiber |
| | | reinforced composite |

| | Temperature of thermal | Tensile strength |
|---|---|---|
| materials | deformation HDT (° C.) | (MPa) |
| PP | 62.6 | 39.3 ± 0.19 |
| PP/10 phr modified fiber | 120.9 | 46.3 ± 0.23 |
| PP/20 phr modified fiber | 130.7 | 53.8 ± 0.28 |
| PP/40 phr modified fiber | 139.0 | 78.6 ± 0.25 |
| PP/60 phr modified fiber | 138.9 | 65.1 ± 0.42 |

As a result, after the natural fibers extracted from naturally occurring materials by the process according to the present invention are conjugated to the main chain of high molecular materials, the thermal stability and mechanical property of high molecular materials can be effectively elevated merely by adding less than 10% (weight %) of such modified fibers. Even though the addition exceeds 40% (weight %), the modified fibers can be still dispersed in the base materials to raise the thermal stability and mechanical property of high molecular materials. Furthermore, because the natural fibers are conjugated to the main chain of high molecular materials by the process according to the present invention, the compatibility and stability of the high molecular materials can be substantially raised and this enables the added amount of the modified fibers to be applied in a wide range. When added to high molecular materials, the rates of increase in both the thermal deformation temperature and the tensile strength can exceed 100%. Moreover, the modified fibers can be homogeneously dispersed in conventional plastics (for example epoxy resins, unsaturated polyesters), rubbers (for example natural rubbers, thermoplastic rubbers, such as TPR), biodegradable plastics (for example aliphatic polyester, polylactic acid) and other base materials to generate eco-friendly reinforced composites. This can not only reduce domestic dependence on synthetic fibers, but also relieve cost pressure on the industrial circles. In addition, because such reinforced materials can further endure higher stress changes and be applied to products employed under high temperature, such as interiorly and exteriorly installed car materials, containers for hot food, heat-resistant containers, cases for electronic and photoelectronic products, this can add the applicability and extra premium of the materials.

The invention has been explained by the preferable embodiment. Persons skilled in the art may, however, make modifications to the present invention, provided that these modifications should be included in the spirit and scope of the invention.

Taken together, the present invention provides natural fibers with excellent properties, which are successfully extracted from naturally occurring materials by a series of chemical, biological and mechanical methods, wherein the generated fibers following treatment with coupling agent and chemical treatment can be successfully conjugated to the main chains of the high molecular materials. As a result, the thermal stability and mechanical property of high molecular materials can be effectively elevated merely by adding less than 10% (weight %) of such modified fibers. Moreover, these modified fibers can be respectively applied to conventional plastics, rubbers and biodegradable plastics to reinforce the mechanical strength of the base materials and to reduce the cost of the materials. There is no doubt about structural change or about improvement in the function. In addition, the present invention has never been either published prior to application or used publicly and hence meets the requirements for patent application.

1. A process for manufacturing high performance natural fiber reinforced composites, wherein natural fibers with excellent properties are mainly extracted from naturally occurring materials and the generated fibers following treatment with coupling agent are successfully conjugated to the main chain of high molecular materials and homogeneously dispersed in the base materials.

2. The process according to claim 1 for manufacturing high performance natural fiber reinforced composites, wherein the naturally occurring materials are pineapples, bamboos, leaves of water bamboo shoot, bananas, pandan trees and sisals etc.

3. The process according to claim 1 for manufacturing high performance natural fiber reinforced composites, wherein the natural fibers are extracted from naturally occurring materials using chemical, biological and mechanical methods.

4. The process according to claim 3 for manufacturing high performance natural fiber reinforced composites, wherein the procedure for fiber extraction is shown as follows:
1) mechanical or biological treatment: first of all, the raw materials are pressed with a squeezer (0.5˜2 hP) or soaked in water in order that they are degraded biologically,
2) degreasing treatment: the fibers generated in the first step are soaked in 2˜5% detergent solution at 40˜80° C. for 1˜3 hr and then washed with water,
3) The fibers generated in the second step are pressed again by a squeezer (0.5˜2 hP),
4) The fibers generated in the third step are washed with water and dried at 80˜120° C. for 6˜24 hr,
5) The fibers generated in step 4 are smashed by a grinding machine (0.5˜2 hP, duration: 2˜10 sec),
6) The fibers generated in step 5 are sieved (20 mesh, 0.84 mm),
7) The fibers generated in step 6 are smashed once again by a grinding machine (0.5˜2 hP, duration: 2˜10 sec) until the desired length is reached; after grinding, fibers of diameter in the range of 0.003˜0.014 mm, length in the range of 0.2˜15 cm and aspect ratio >50 are generated.

5. The process according to claim 4 for manufacturing high performance natural fiber reinforced composites, wherein the fibers generated in step 6 are sieved and the sieve used is 20 mesh and 0.84 mm.

6. The process according to claim 1 for manufacturing high performance natural fiber reinforced composites, wherein the coupling agent is mixed with acetone in the ratio of 3:100 (V/V) and stirred at room temperature; the fibers are then weighed out and mixed with acetone in the proportion of 25:1000 (W/V); then the mixture is added to the coupling agent; 5 g of filling agent and 0.5 g of silane are added to the mixture and stirred at room temperature for 30˜60 min and subsequently let stand for 10˜30 min.

7. The process according to claim 1 for manufacturing high performance natural fiber reinforced composites, wherein the modified fibers are mixed with high molecular materials (biodegradable plastics or conventional high molecular materials) and diverse conjugation reactions are designed in accordance with the chemical structural features of the high molecular materials in order to conjugate the fibers to the main chain of the high molecular materials.

8. The process according to claim 1 for manufacturing high performance natural fiber reinforced composites, wherein the thermal stability and mechanical property of high molecular materials are effectively elevated by adding less than 10% (weight %) of the natural fibers to the base materials.

9. The process according to claim 1 for manufacturing high performance natural fiber reinforced composites, wherein the modified fibers are still dispersed in the base materials even though more than 40% (weight %) of the natural fibers are added to the base materials and the thermal stability and mechanical property of high molecular materials are also effectively elevated.

10. The process according to claim 1 for manufacturing high performance natural fiber reinforced composites, wherein the suitable base materials for the modified fibers are conventional plastics.

11. The process according to claim 1 for manufacturing high performance natural fiber reinforced composites, wherein the suitable base materials for the modified fibers are rubbers.

12. The process according to claim 1 for manufacturing high performance natural fiber reinforced composites, wherein the suitable base materials for the modified fibers are biodegradable plastics.
